(19) United States
(12) Patent Application Publication
(10) Pub. No.: US 2011/0074534 A1
(43) Pub. Date: Mar. 31, 2011

(54) TRANSFORMER FOR A COMPUTER TOMOGRAPHY GANTRY

(75) Inventors: Christoph Loef, Aachen (DE); Johannes Bathasar Maria Soetens, Esbeek (NL)

(73) Assignee: Koninklijke Philips Electronics N.V., Eindhoven (NL)

(21) Appl. No.: 12/994,482

(22) PCT Filed: May 27, 2009
(86) PCT No.: PCT/IB2009/052222

§ 371 Date: Nov. 24, 2010

(30) Foreign Application Priority Data
Jun. 2, 2008 (EP) 08104194.9

(51) Int. Cl. H01F 27/28

(52) U.S. Cl. 336/170

(57) ABSTRACT

The invention provides a transformer for a computer tomography gantry (91) for transfering contactlessly electrical energy from a stationary part of the gantry (92) to a rotary part of the gantry (93), wherein the transformer comprises a set of primary windings (103, 105, 203, 204), a set of secondary windings (103, 105, 203, 204), a set of first cores (101, 202, 301), a set of second cores (101, 202, 301), wherein the set of primary windings (103, 105, 203, 204) being arranged at the set of first cores (101, 202, 301) on the stationary part of the gantry (92), such that a winding of the set of primary windings (103, 105, 203, 204) is adapted to induce a magnetic flux into a core of the set of first cores (101, 202, 301), wherein the set of secondary windings (103, 105, 203, 204) being arranged at the set of second cores (101, 202, 301) on the rotary part of the gantry (93), such that a winding of the set of secondary windings (103, 105, 203, 204) is adapted to induce a magnetic flux into a core of the set of second cores (101, 202, 301), wherein the set of first cores (101, 202, 301) and the set of second cores (101, 202, 301) are adapted to reduce mechanical resonant vibrations caused by the rotation of the rotary part of the gantry (93). Another aspect of the invention is a computer tomography gantry (91) comprising a transformer according to the invention.

### FIELD OF THE INVENTION

The present invention relates to a transformer for a computer tomography gantry for transfering contactlessly electrical energy from a stationary part of the gantry to a rotary part of the gantry and a computer tomography gantry comprising such a transformer.

### BACKGROUND OF THE INVENTION

For high power computer tomography applications the x-ray tube power must be transferred to the rotating gantry. This is currently done by mechanical slip-rings. For high power applications it is necessary to use a rotary power transformer with a stationary primary winding and a secondary winding on the rotating part of the gantry. The power transformer has a circular outline in which the inner diameter is determined by the given inner bore of the computer tomography system. The rotary power transformer comprises a set of E-cores.

### SUMMARY OF THE INVENTION

Due to the fact that a part of the gantry is stationary and another part of the gantry is rotating mechanical bending and mechanical tilting of the rotating part of the gantry is possible. The bending and tilting is caused by electromagnetic forces between the stationary part of the gantry and the rotary part of the gantry. In case of a high rotation speed of the rotary part of the gantry the bending and tilting can result in mechanical resonance and in a worst case scenario the power transformer can be destroyed.

It would be desireable to provide an improved device for prevention of a bending and tilting caused by the rotation of the rotary part of the gantry.

The invention provides a transformer for a computer tomography gantry for transfering contactlessly electrical energy from a stationary part of the gantry to a rotary part of the gantry, wherein the transformer comprises a set of primary windings, a set of secondary windings, a set of first cores, a set of second cores, wherein the set of primary windings being arranged at the set of first cores on the stationary part of the gantry, such that a winding of the set of primary windings is adapted to induce a magnetic flux into a core of the set of first cores, wherein the set of secondary windings being arranged at the set of second cores on the rotary part of the gantry, such that a winding of the set of secondary windings is adapted to induce a magnetic flux into a core of the set of second cores, wherein the set of first cores and the set of second cores are adapted to reduce mechanical resonant vibrations caused by the rotation of the rotary part of the gantry.

In other words the invention deals with the problem of mechanical fluctuations due to the rotation of the rotary part of the gantry. These mechanical fluctuations result in mechanical bending and tilting of the rotary part of the gantry. Therefore, the speed of rotation can be limited to a maximum speed because of these mechanical problems. The worst case scenario is a rotation of the rotary part of the gantry with the eigenfrequency of the mechanical arrangement of the rotary part of the gantry. In this case the bending and tilting arrives at a maximum. Resulting the above-mentioned these mechanical problems could result in damages to the whole computer tomography gantry. The solution to this problem provided by this invention is to break through the symmetry of the arrangement with the help of a special arrangement of the cores of the primary side of the transformer and the secondary side of the transformer.

Further, the invention provides a computer tomography gantry comprising a transformer according to one of the claims 1 to 11.

Further embodiments are incorporated in the dependent claims.

According to the present invention it is provided a transformer, wherein the number of the cores of the set of first cores is different to the number of cores of the set of second cores.

Different numbers of cores on the primary side of the transformer and the secondary side of the transformer leads to a wished unbalance of the arrangement. This unbalance prevents the appearance of eigenfrequencies of the mechanical arrangement. Therefore, an operation of mode of the computer tomography gantry without limits with respect of the speed of the rotation is possible.

According to an exemplary embodiment it is provided a transformer, wherein the dimensions of the cores of the set of first cores are different.

According to the present invention it is provided a transformer, wherein the dimensions of the cores of the set of second cores are different.

It is also possible to use different kinds of cores with respect to the mechanical dimensions of the cores. Usually, it will be used cores with different cross sectional areas. This leads to differences with respect to the magnetic flux, which will be conducted within the cores. These differences of the magnetic flux prevents the appearance of eigenfrequencies of the mechanical arrangement of the rotary part of the gantry. It does not matter which set of cores is changed with respect to the usual arrangement of a set of cores. But it is important to arrive at different arrangements of cores on the primary side of the transformer and the secondary side of the transformer.

Especially, it is advantageously to use cores with different widths of the cross-section. The different widths of the cross-section can be seen best with respect to the cross-section of the rotary part of the gantry and the stationary part of the gantry, respectively.

According to an exemplary embodiment it is provided a transformer, wherein the smallest distances between the cores of the set of first cores are different.

According to an exemplary embodiment it is provided a transformer, wherein the smallest distances between the cores of the set of second cores are different.

It is also a possibility to provide an arrangement of cores with different air gaps between the single cores. Such an arrangement leads also to the effect of prevention of mechanical fluctuations. The air gaps can be considered as gaps between the single cores, wherein the air-gaps can be seen best in a cross-section of the rotary part of the gantry or a cross-section of the stationary part of the gantry.

According to an exemplary embodiment it is provided a transformer, wherein the dimensions of the cores of the set of first cores and the dimensions of the cores of the set of second cores are different.

According to an exemplary embodiment it is provided a transformer, wherein the cores of the set of first cores and the cores of the set of second cores are E-shaped.

According to another exemplary embodiment it is provided a transformer, wherein the cores of the set of first cores and the cores of the set of second cores are U-shaped.

According to an exemplary embodiment it is provided a transformer, wherein the cores of the set of first cores are arranged in a first circle with a centerline, wherein the cores of the set of second cores are arranged in a second circle with the centerline, wherein a core out of the group consisting of the set of first cores and the set of second cores is rotated with an angle around the axis of rotation of the core, wherein the axis of rotation is parallel with the centerline.

According to another exemplary embodiment it is provided a transformer, wherein the angle is between −10 and +10 degrees.

It may be seen as a gist of the present invention to provide a mechanical arrangement, which avoids bending and tilting of the rotary part of the gantry especially the bending with eigenfrequencies.

It should be noted that the above features may also be combined. The combination of the above features may also lead to synergetic effects, even if not explicitly described in detail.

These and other aspects of the present invention will become apparent from and elucidated with reference to the embodiments described hereinafter.

### BRIEF DESCRIPTION OF THE DRAWINGS

Exemplary embodiments of the present invention will be described in the following with reference to the following drawings.

FIG. 1 shows a part of a transformer,

FIG. 2 shows schematically a part of a transformer,

FIG. 3 shows an arrangement of cores.

FIG. 4 shows a computer tomography gantry.

### DETAILED DESCRIPTION OF EMBODIMENTS

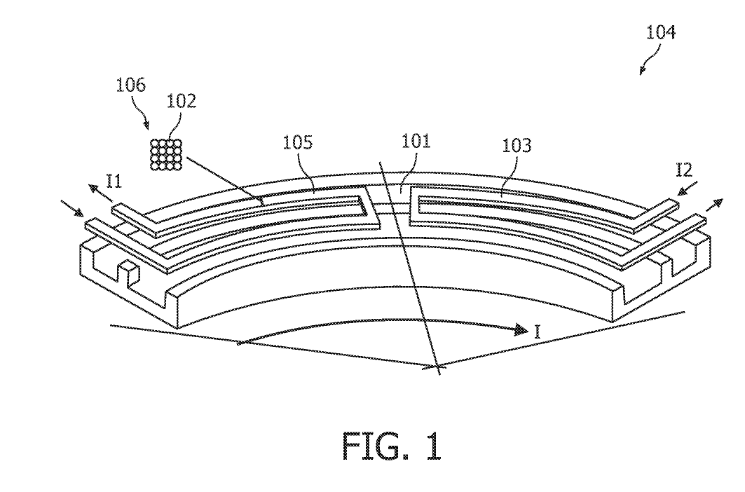

FIG. 1 describes a part of a transformer 104. It is depicted a first winding 105 and a second winding 103, wherein the first winding 105 is supplied by a current Il and the second winding 103 is supplied by a current I2. It is also depicted a cross-section of the first winding 106, wherein different strands 102 can be recognized. The transformer 104 comprises a core 101, which is E-shaped.

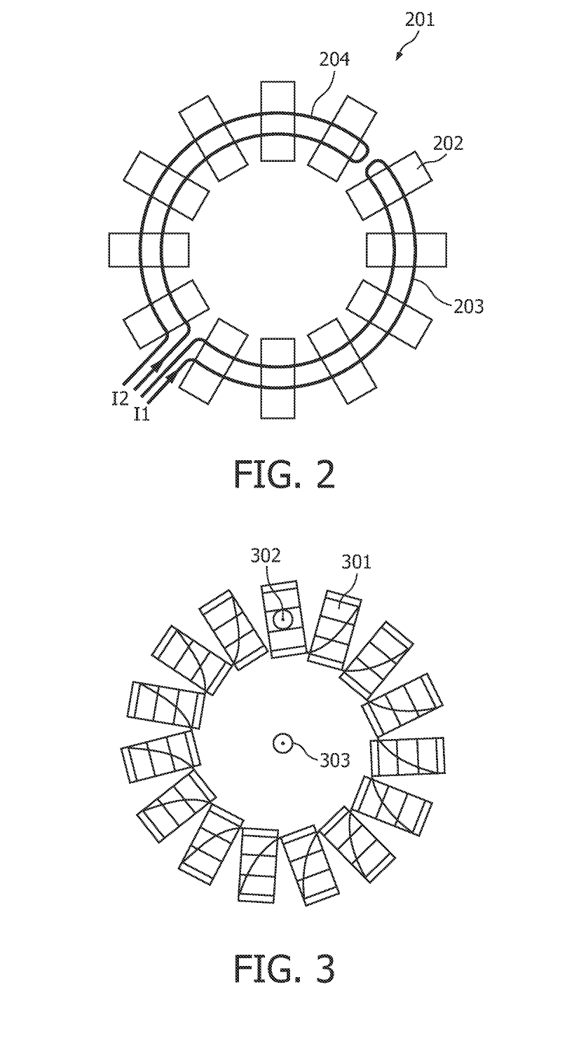

FIG. 2 shows a part of a transformer 201. It is depicted a first winding 203, which is supplied by a current I1. It is also depicted a second winding 204, which is supplied by a second current I2. The arrangement is completed by an arrangement of cores 202. The arrangement can be interpreted as part of the primary part of the transformer 201 or as a part of the secondary part of the transformer 201.

Typically the total core of a rotary power transformer comprises a plurality of E-cores 202, which are arranged in a circle. The diameter of this circle is determined by the inner bore of the computer tomography system. There is a circle of cores 202 at the primary side of the power transformer and at the secondary side of the power transformer.

If equal numbers of E-cores 202 are arranged at the primary and the secondary side of the rotary transformer, mechanical oszillations can occur during rotation of the rotary part of the gantry.

A first embodiment of the invention uses unequal numbers of E-cores 202 at the primary and the secondary side of the transformer. As an example the primary side of the transformer can comprise 12 cores 202 and the secondary side can comprise 13 cores 202. With the use of unequal numbers of cores on the primary and the secondary side the resulting cogging torque can be reduced for a desired rotational speed or range of speed. Using unequal number of E-cores on the primary and secondary side the noise generated by the rotation will be reduced also.

A second embodiment of the invention uses U-shaped cores, which can be used for lower power applications. A different number of cores on the secondary and the primary side of the power transformer results in reduction of bending and tilting and noise generation.

A third embodiment of the invention uses E-cores 301 which have a slight angular rotation (e.g. 1 . . . 10°) around their center line 302. One advantage of this arrangement is the improved magnetic coupling, since there is more overlap between the E-cores 301 during rotation. A further advantage can be seen in the better cooling of the E-cores 301 which is caused by more airflow generated during rotation.

FIG. 3 shows an arrangement of cores 301, wherein the cores are rotated by an angle around the center line 302. The center line 302 is parallel to the center line 303 of the circle, which is achieved by the arrangement of the cores 301.

The invention solves especially two problems. Especially, the mechanical bending and tilting of the rotary transformer caused by magnetic forces between the rotary part of the gantry and the stationary part of the gantry will be reduced or eliminated. Further, the noise, generated by the rotation of the rotary part of the gantry will be reduced or eliminated.

According to the inventive concept the fact, that the air-gaps between the mechanical and magnetic components of the rotary contactless transformer could lead to acoustical noise due to the rotation of the rotary part of the gantry and the air accelerated by the rotation, can be avoided.

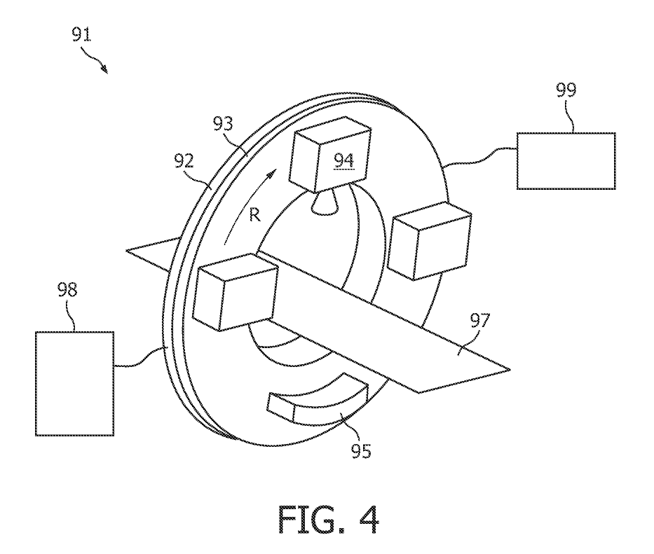

FIG. 4 shows an exemplary embodiment of a computer tomography gantry 91 arrangement. The gantry 91 comprises a stationary part 92 connected to a high frequency power source 98 and a rotary part 93 adapted to rotate relative to the stationary part 92. An X-ray source 94 and an X-ray detector 95 are attached to the rotary part 93 at opposing locations such as to be rotatable around a patient positioned on a table 97. The X-ray detector 95 and the X-ray source 94 are connected to a control and analysing unit 99 adapted to control the X-ray detector 95 and the X-ray source and to evaluate the detection results of the X-ray detector 95.

It should be noted that the term ‘comprising’ does not exclude other elements or steps and the ‘a’ or ‘an’ does not exclude a plurality. Also elements described in association with the different embodiments may be combined.

It should be noted that the reference signs in the claims shall not be construed as limiting the scope of the claims.

### LIST OF REFERENCE SIGNS

91 Computer tomography gantry,

92 Stationary part of the gantry,

93 Rotary part of the gantry,

94 X-ray source,

95 X-ray detector,

97 Table,

98 High frequency power source,

99 Control and analysing unit,

101 Core,

102 Strand,

103 Winding,

104 Part of transformer,

105 Winding,

106 Cross-section of a winding,

201 Part of transformer,

202 Core,

203 First winding,

204 Second winding,

301 Core,

302 Center line of a single core,

303 Center line of an arrangement of cores.

1. A transformer for a computer tomography gantry (91) for transfering contactlessly electrical energy from a stationary part of the gantry (92) to a rotary part of the gantry (93),
wherein the transformer comprises
a set of primary windings (103, 105, 203, 204),
a set of secondary windings (103, 105, 203, 204),
a set of first cores (101, 202, 301),
a set of second cores (101, 202, 301),
wherein
the set of primary windings (103, 105, 203, 204) being arranged at the set of first cores (101, 202, 301) on the stationary part of the gantry (92), such that a winding of the set of primary windings (103, 105, 203, 204) is adapted to induce a magnetic flux into a core of the set of first cores (101, 202, 301),
wherein
the set of secondary windings (103, 105, 203, 204) being arranged at the set of second cores (101, 202, 301) on the rotary part of the gantry (93), such that a winding of the set of secondary windings (103, 105, 203, 204) is adapted to induce a magnetic flux into a core of the set of second cores (101, 202, 301), wherein the set of first cores (101, 202, 301) and the set of second cores (101, 202, 301) are adapted to reduce mechanical resonant vibrations caused by the rotation of the rotary part of the gantry (93).

2. The transformer according to claim 1, wherein the number of the cores of the set of first cores (101, 202, 301) is different to the number of cores of the set of second cores (101, 202, 301).

3. The transformer according to claim 1, wherein the dimensions of the cores of the set of first cores (101, 202, 301) are different.

4. The transformer according to claim 1, wherein the dimensions of the cores of the set of second cores (101, 202, 301) are different.

5. The transformer according to claim 1, wherein the smallest distances between the cores of the set of first cores (101, 202, 301) are different.

6. The transformer according to claim 1, wherein the smallest distances between the cores of the set of second cores (101, 202, 301) are different.

7. The transformer according to claim 1, wherein the dimensions of the cores of the set of first cores (101, 202, 301) and the dimensions of the cores of the set of second cores (101, 202, 301) are different.

8. The transformer according to claim 1, wherein the cores of the set of first cores (101, 202, 301) and the cores of the set of second cores (101, 202, 301) are E-shaped.

9. The transformer according to claim 1, wherein the cores of the set of first cores (101, 202, 301) and the cores of the set of second cores (101, 202, 301) are U-shaped.

10. The transformer according to claim 1, wherein the cores of the set of first cores (101, 202, 301) are arranged in a first circle with a centerline, wherein the cores of the set of second cores (101, 202, 301) are arranged in a second circle with the centerline, wherein a core out of the group consisting of the set of first cores (101, 202, 301) and the set of second cores (101, 202, 301) is rotated with an angle around the axis of rotation of the core, wherein the axis of rotation is parallel with the centerline.

11. The transformer according to claim 10, wherein the angle is between −10 and +10 degrees.

12. A computer tomography gantry (91) comprising a transformer according to claim 1.
